(19) United States
(12) Patent Application Publication
(10) Pub. No.: US 2026/0369251 A1
(43) Pub. Date: Nov. 19, 2026

(54) MUSICAL INSTRUMENT WITH THREE-SECTION STRING NETWORKS

(71) Applicant: Claude Gauthier, Dieppe (CA)

(72) Inventor: Claude Gauthier, Dieppe (CA)

(21) Appl. No.: 19/679,640

(22) Filed: May 16, 2026

(30) Foreign Application Priority Data
May 16, 2025 (GB) 2507623.3

(51) Int. Cl. G10D 3/12; G10D 1/08; G10D 3/04; G10D 3/053; G10D 3/06; G10D 3/10

(52) U.S. Cl. CPC G10D 3/12; G10D 1/085; G10D 3/04; G10D 3/053; G10D 3/06; G10D 3/10

(57) ABSTRACT

A stringed musical instrument includes a frame having a generally inverted-Y configuration with a central body portion and three necks extending therefrom. At least one string network is supported by the frame and includes first, second, and third string sections mechanically coupled together at a junction ring, with opposite ends anchored to respective necks so that the string sections define a single coupled generally inverted-Y topology. The central body portion may define a central cavity in which the junction ring is disposed. A first string may carry the junction ring, and a second string may be threaded through the junction ring to form two string sections whose relative lengths are adjustable before anchoring. String-section lengths, angles, and linear densities may be selected to produce quasi-harmonic or non-harmonic vibrational spectra. The instrument may include multiple aligned string networks, a retractable string-installation device, a movable bridge, and a capo.

### CROSS-REFERENCE TO RELATED APPLICATIONS

This application claims priority to and the benefit of United Kingdom patent application No. GB2507623.3, filed May 16, 2025, the entire disclosure of which is hereby incorporated by reference herein.

### FIELD OF THE INVENTION

The present invention relates generally to musical instruments with three-section string networks.

### BACKGROUND OF THE INVENTION

A musical instrument is generally said to emit a musical sound when its frequency spectrum consists of frequencies that are integer multiples of a lowest, fundamental frequency, the higher integer multiples being commonly referred to as harmonics. By this definition, an ordinary vibrating taut string emits a musical sound, whereas membranes such as drumheads typically emit non-harmonic sounds.

Stringed musical instruments such as the guitar, the bass guitar, the violin, and the harp produce sounds by exciting one or more strings stretched between two anchor points along a substantially linear path. Each such string vibrates principally as a one-dimensional system, and the resulting frequency spectrum is substantially harmonic. While such instruments are well suited to the production of conventional music, the substantially harmonic nature of their output limits the timbral and compositional palette available to the musician.

A number of stringed instruments employing more than one string network have been proposed in the prior art. By way of example, U.S. Pat. Nos. 497,939, 1,022,031, and British Patent No. GB189811543 each describe a guitar-like instrument having two parallel and independent networks of strings anchored on a widened bridge. U.S. Pat. No. 860,137 describes a stringed instrument having two independent string networks, one horizontal and one inclined. U.S. Pat. No. 7,763,785 and Canadian Patent No. CA 2,466,645 describe stringed instruments having multiple string networks, but the supporting and anchoring structure is shown only in summary form. U.S. Pat. No. 10,891,925 describes a stringed instrument having three string networks; however, the three networks of that instrument are independent of one another and are not interconnected.

None of the foregoing prior art references describes a stringed instrument in which a plurality of string sections of a single network are joined together at a junction ring to define a generally inverted-Y string topology, in which a corresponding plurality of inverted-Y string networks may be stacked one above another along a common vertical axis through their junction rings, or in which the geometric and physical characteristics of the string sections of each such network are selected so as to render the spectrum of vibrational frequencies of the network substantially quasi-harmonic. Furthermore, the prior art does not describe an arrangement permitting a musician to selectively transition between substantially quasi-harmonic and frankly non-harmonic operation by appropriate selection of the linear densities of the string sections forming each network.

Accordingly, there exists a need for a stringed musical instrument that overcomes the foregoing limitations of the prior art and that provides for the production of selectively quasi-harmonic and non-harmonic sounds by means of a structurally novel arrangement of three-section string networks.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide a stringed musical instrument that overcomes at least some of the limitations of the prior art.

In accordance with one aspect of the present invention, there is provided a stringed musical instrument comprising a frame having a generally inverted-Y configuration, the frame comprising a central body portion and first, second and third necks extending outwardly from the central body portion; and at least one string network supported by the frame, the at least one string network comprising a first string section, a second string section, and a third string section, each of the first, second and third string sections having a first end and a second end, the first ends of the first, second and third string sections being joined together at a junction ring, and the second ends of the first, second and third string sections being anchored, respectively, to the first, second and third necks of the frame, such that the at least one string network adopts a generally inverted-Y configuration substantially conforming to the inverted-Y configuration of the frame.

In accordance with another aspect of the present invention, the instrument may comprise a plurality of such string networks supported by the frame in mutually parallel planes, the junction rings of the plurality of string networks being substantially aligned along a common axis extending substantially perpendicular to said planes when the plurality of string networks are tensioned and tuned, such that the plurality of string networks are caused to vibrate substantially independently of one another.

In accordance with a further aspect of the present invention, the geometric and physical characteristics of the first, second and third string sections of each said string network may be selected such that the spectrum of vibrational frequencies of the said string network, when plucked or otherwise excited, is substantially quasi-harmonic. In a particularly preferred embodiment, the lengths of the first, second and third string sections of each said string network are in proportions of 1, ½, and 7/25, respectively.

In accordance with yet a further aspect of the present invention, there is provided a retractable string-installation device disposed at an edge of a central cavity of the frame, the retractable string-installation device having a plurality of notches each adapted to receive a ring affixed to a respective string and to retain the said string in position during initial installation of the corresponding string network.

In accordance with another aspect of the present invention, the instrument may comprise a movable bridge disposed adjacent the central cavity, the movable bridge being movable between an operative position for supporting or positioning at least one string section and a retracted position for facilitating installation, removal, adjustment, or tuning of the string network.

In accordance with another aspect of the present invention, the instrument may comprise a capo movable between a released position and an engaged position, the capo being configured, in the engaged position, to bear against at least one string section of a string network to selectively shorten an effective vibrating length of the string section.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1A showing the junction ring or ball end, portions of the first and second strings, a movable bridge, and a capo.

FIG. 1B is an enlarged isometric view of the central cavity region of the instrument of FIG. 1A, showing the junction ring or ball end, portions of the first and second strings, a movable bridge, and a capo.

FIG. 1C is an enlarged isometric view of the end portion of one of the string section necks of the instrument of FIG. 1A, showing a fine-tuning bridge.

FIG. 2A is a front view of a stringed musical instrument according to a second embodiment of the present invention, in which the instrument is configured as a headless instrument.

FIG. 2B is an enlarged isometric view of the tensioning knobs disposed at the end portion of one of the necks of the instrument FIG. 2A.

FIG. 2C is a side elevation view of the instrument of FIG. 2A, showing the inverted-Y configuration of the frame and the position of the central cavity.

FIG. 2D is an enlarged isometric view of the central cavity of the instrument of FIG. 2A, showing the retractable string-installation device and the string ball ends.

### DETAILED DESCRIPTION OF THE PREFERRED EMBODIMENT

The following description is provided to enable any person skilled in the art to make and use the invention and sets forth the best modes contemplated by the inventor of carrying out the invention. Various modifications, however, will remain readily apparent to those skilled in the art, since the general principles of the present invention have been defined herein to specifically provide musical instruments with three-section string networks.

As used herein, terms of approximation such as “generally,” “substantially,” and “about” are intended to account for ordinary manufacturing tolerances, measurement tolerances, tuning adjustments, string stretch, material variation, and design variations that do not materially change the function or configuration being described. For example, a “generally inverted-Y” configuration need not form an exact mathematical Y-shape, but may include curved, angled, offset, asymmetric, or otherwise varied frame or string-section arrangements that provide three branches extending from a common junction or central region. Unless a narrower meaning is required by the context, the term “about” when used with numerical values may encompass variations of ±10% from the stated value, as well as other variations that produce substantially the same functional result.

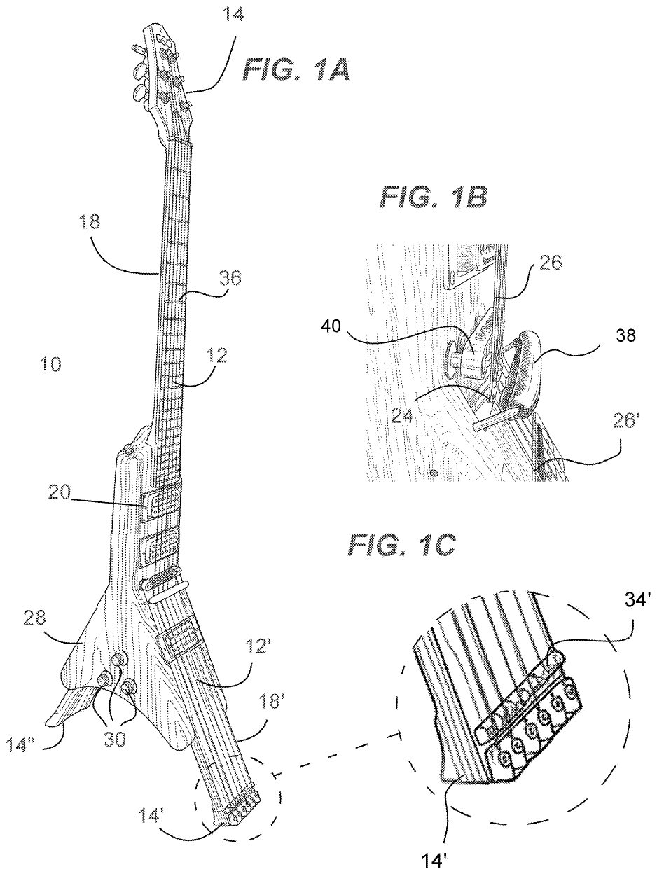

Referring now to the drawings, and in particular to FIGS. 1A through 1C, there is shown a stringed musical instrument 10 according to a first embodiment of the present invention. The instrument 10 comprises a frame having a generally inverted-Y configuration. The frame comprises a central body portion 28 from which extend first, second, and third necks 18, 18′, 18″. The first neck 18 extends generally upwardly from the central body portion 28 and serves as the principal neck of the instrument 10, while the second and third necks 18′, 18″ extend obliquely downwardly and outwardly from the central body portion 28.

The instrument 10 supports a plurality of string networks, each comprising three string sections 12, 12′, 12″ arranged in a generally inverted-Y configuration substantially conforming to the inverted-Y configuration of the frame. The first neck 18 terminates in a head 14, and the second and third necks 18′, 18″ terminate in respective end portions or feet 14′, 14″. The feet 14′, 14″ may be flared outwardly so as to render the instrument 10 self-supporting and stable when placed in a substantially vertical position.

The first, second and third string sections 12, 12′, 12″ of each string network are joined together at a junction located within a central cavity 16 of the central body portion 28. The junction is effected by means of a small ring or ball end 24 affixed to one end of a first string 26 forming the first string section 12. A second string 26′ is threaded through the ring or ball end 24 and is drawn therethrough so that two free portions of the second string 26′ extend outwardly to opposite sides of the ring 24 to form the second string section 12′ and the third string section 12″, respectively. The lengths of the second and third string sections 12′, 12″ may be adjusted by sliding the second string 26′ through the ring 24 until the desired lengths are obtained, prior to anchoring the second string 26′ at its two ends to the second and third necks 18′, 18″.

In a particularly preferred geometric configuration, the first string section 12 and the second and third string sections 12′, 12″ have lengths that are in proportions of 1, ½, and 7/25, respectively. In this preferred configuration, the second and third string sections 12′, 12″ subtend an angle of approximately 60 degrees between them, and each of the second and third string sections 12′, 12″ subtends an angle of approximately 150 degrees with the first string section 12. As will be set forth in greater detail hereinbelow, this geometric configuration, when combined with appropriate selection of linear densities, gives rise to a vibrational spectrum that is substantially quasi-harmonic.

The first string section 12 on the one hand, and the second and third string sections 12′, 12″ on the other hand, may be of the same linear density or of different linear densities. Where the harmony of the sounds produced by the network is to be maximized, all three string sections 12, 12′, 12″ are preferably of the same linear density. Conversely, where strongly non-harmonic sounds are sought, the linear densities of the first string section 12 and of the second and third string sections 12′, 12″ may be selected to differ from one another. In this manner, the musician may select between substantially quasi-harmonic and frankly non-harmonic operation by appropriate choice of strings.

The instrument 10 supports a plurality of such string networks, the string networks having different linear densities such that the said networks vibrate substantially independently of one another. The central cavity 16 disposed at the junction of the three necks 18, 18′, 18″ permits the junction rings 24 of the several string networks to occupy mutually superimposed positions along a common vertical axis when the said networks are tensioned and tuned. A visual reference may be provided along an edge of the central cavity 16 to facilitate alignment of the junction rings 24 along the said common axis.

The end of the third string section 12″ that is remote from the junction ring 24 is anchored to the third neck 18″ by means of a tensioning device comprising a tensioning knob 32. Adjustment of the tensioning knob 32 permits the tension in the third string section 12″ to be varied, which in turn permits the position of the junction ring 24 along the said common vertical axis to be adjusted, so that the junction rings 24 of all of the string networks may be brought into substantial mutual alignment when all of the said networks are tensioned and tuned. The end of the second string section 12′ is anchored directly to the second neck 18′ by way of a fixed anchor, and an adjacent bridge 34′ is provided at the second neck 18′ for fine-tuning the harmony of the vibrations of the corresponding string network.

In some embodiments, the instrument 10 further comprises a movable bridge 38 disposed adjacent the central cavity 16. The movable bridge 38 may be movable between an operative position and a retracted position. In the operative position, the movable bridge 38 supports or positions at least one of the string sections 12, 12′, 12″ relative to the central body portion 28. In the retracted position, the movable bridge 38 is displaced away from the corresponding string section to facilitate installation, removal, adjustment, or tuning of one or more of the string networks. The movable bridge 38 may be pivotable, slidable, or otherwise displaceable relative to the central body portion 28.

In some embodiments, the instrument 10 further comprises a capo 40 positioned adjacent the central cavity 16 or along one of the necks 18, 18′, 18″. The capo 40 is movable between a released position and an engaged position. In the engaged position, the capo 40 bears against at least one string section of a corresponding string network to selectively shorten an effective vibrating length of the string section. In the released position, the capo 40 is spaced from the string section so that the string section may vibrate without being stopped by the capo 40. The capo 40 may be pivotably mounted, slidably mounted, or removably mounted to the frame.

The first neck 18 is provided with a plurality of frets 36 along the length thereof. The frets 36 may be disposed in the same manner as the frets of conventional stringed instruments such as the guitar or bass guitar, so that the musician may stop the first string section 12 of any of the string networks at any selected fret 36 in conventional manner. The first neck 18 is, in this first embodiment, further provided with a head 14 at the end thereof remote from the central body portion 28, the head 14 carrying a plurality of tuning keys for terminal tuning of the first string sections 12 of the several string networks.

The vibrations of the string networks are sensed and converted to electrical signals by means of a plurality of pickups 20, which may be of the electromagnetic type as is well known in the art of electric guitars. The pickups 20 are mounted on the necks 18, 18′, 18″ beneath the corresponding string sections 12, 12′, 12″. Electronic components for selecting and adjusting the gain of each pickup 20 are concealed beneath an upper surface of the central body portion 28, and may be controlled by way of a plurality of control knobs 30 (e.g., volume and tone). An output jack is provided on the central body portion 28 for connection of the instrument 10 to an external amplifier or other electrical apparatus.

Two strap-anchor buttons may be affixed to the central body portion 28 to permit a strap to be secured to the instrument 10, so that a musician may play the instrument 10 from a standing position. The shape of the central body portion 28 may also be adapted to permit the musician to play the instrument 10 from a seated position. A portion of the third neck 18″, proximate to the tensioning knobs 32, is preferably of reduced thickness so as to facilitate manipulation of the tensioning knobs 32.

The first, second, and third necks 18, 18′, 18″ are each affixed to the central body portion 28 by means of four anchoring bolts arranged so as not to be visible from the side of the instrument 10 facing the musician during play.

Without wishing to be bound by any particular theory, it is presently understood that the substantially quasi-harmonic character of the sounds emitted by the string networks of the present invention arises from the boundary conditions imposed by the inverted-Y topology in conjunction with the linear densities and lengths of the constituent string sections. The vibrational modes of such a network are governed by a partial differential equation of the wave type, subject to coupling conditions at the junction ring 24 and to fixed boundary conditions at the second ends of the three string sections 12, 12′, 12″. The optimal values of the geometric and physical characteristics of the string network—including, without limitation, the relative lengths of the string sections, the angles subtended therebetween, and the linear densities thereof—may be obtained by solving the eigenvalue equation associated with the said partial differential equation, so as to identify configurations for which a maximum proportion of the eigenvalues correspond to integer or near-integer multiples of a fundamental frequency. The geometric configuration set forth hereinabove (lengths in proportions of 1, ½ and 7/25; angles of 60 and 150 degrees) is one such configuration.

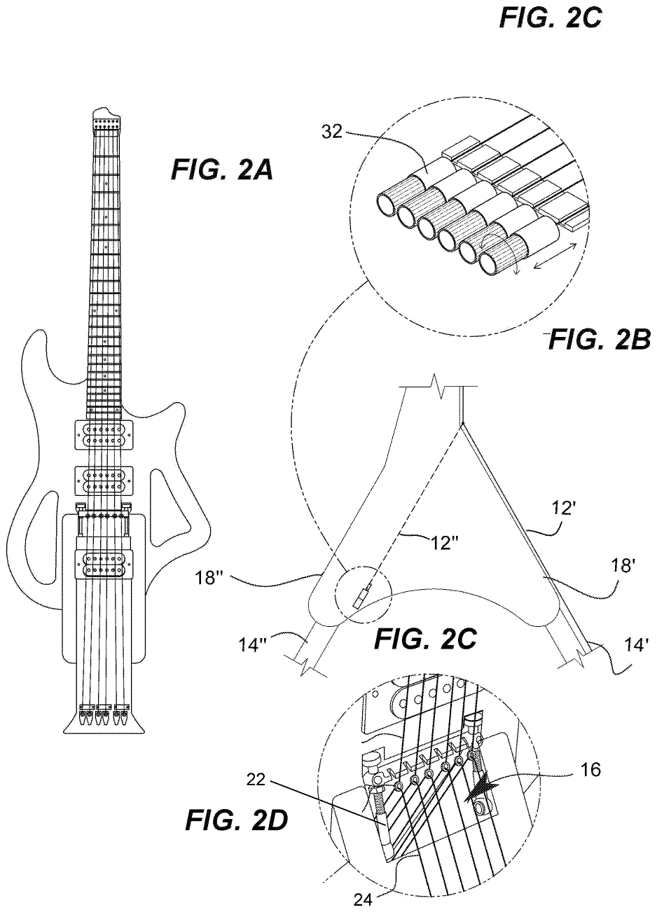

Referring now to FIGS. 2A through 2C, there is shown a stringed musical instrument 10 according to a second embodiment of the present invention. In this second embodiment, the instrument 10 is configured as a headless instrument; that is, no head 14 carrying tuning keys is provided at the end of the first neck 18 remote from the central body portion 28. Instead, the first string sections 12 of the several string networks are anchored at their first-neck ends by means of a screw or like fastener disposed at or near the said remote end of the first neck 18, and the terminal tuning of each said string network is effected by means of the corresponding tensioning knob 32 disposed at the third neck 18″.

As shown in FIG. 2B, because the headless configuration does not provide a tuning key at the end of the first neck 18, the initial installation of the string networks may, in the absence of additional provision, be inconvenient. To facilitate such initial installation, the instrument 10 of the second embodiment is provided with a retractable string-installation device 22 disposed along an edge of the central cavity 16. The retractable string-installation device 22 is movable between a retracted position, in which the said device 22 is housed within the central cavity 16, and a deployed position, in which the said device 22 projects from the central cavity 16.

The retractable string-installation device 22 has a plurality of notches, each notch being adapted to receive a ring 24 affixed to one end of a respective first string 26 forming a respective first string section 12. To install a string network, the retractable string-installation device 22 is moved to its deployed position, and the ring 24 of the first string 26 is introduced into one of the notches of the device 22. The free end of the first string 26 is then drawn over the first neck 18 and is anchored at the said remote end of the first neck 18 by means of the said screw. The second string 26′ is then threaded through the ring 24 and the two free ends thereof are drawn over the second and third necks 18′, 18″ and are anchored thereto. The retractable string-installation device 22 is then moved back to its retracted position, and the corresponding string network is tensioned and tuned by means of the tensioning knob 32 at the third neck 18″. When all of the string networks have been installed and tuned in this manner, the retractable string-installation device 22 remains in its retracted position within the central cavity 16.

It will be appreciated that, although the foregoing detailed description has been made by reference to particular embodiments illustrated in the drawings, the present invention is not limited to those particular embodiments. Numerous variations and modifications will occur to those skilled in the art without departing from the scope of the invention as defined by the appended claims. By way of non-limiting example: the number of string networks supported by the instrument 10 may be varied; the lengths and linear densities of the string sections may be selected to produce vibrational spectra ranging from substantially harmonic, through quasi-harmonic, to frankly non-harmonic; the angles subtended between the string sections may differ from those described hereinabove; the pickups 20 may be of the piezoelectric, optical, or other type, in addition to or in lieu of the electromagnetic type; and the central body portion 28 may take any of a variety of shapes adapted to the ergonomic preferences of the musician.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A stringed musical instrument, comprising:
a frame having a generally inverted-Y configuration, the frame including a central body portion, a first neck extending generally upwardly from the central body portion, and second and third necks extending obliquely downwardly and outwardly from the central body portion;
at least one string network supported by the frame, the at least one string network comprising a first string section, a second string section, and a third string section, each of the first, second, and third string sections having a first end and a second end;
wherein the first ends of the first, second, and third string sections are mechanically coupled together at a junction ring;
wherein the second ends of the first, second, and third string sections are anchored, respectively, to the first, second, and third necks of the frame; and
wherein the first, second, and third string sections extend from the junction ring to the first, second, and third necks, respectively, to define a single coupled string network having a generally inverted-Y topology.

2. The stringed musical instrument of claim 1, wherein the central body portion defines a central cavity, and wherein the junction ring is disposed within the central cavity.

3. The stringed musical instrument of claim 1, wherein the first string section is formed by a first string having the junction ring affixed to the first end of the first string, and wherein the second and third string sections are formed by respective portions of a second string threaded through the junction ring.

4. The stringed musical instrument of claim 3, wherein the second string is slidable through the junction ring to adjust relative lengths of the second and third string sections before the second string is anchored to the second and third necks.

5. The stringed musical instrument of claim 1, wherein the first, second, and third string sections have lengths in proportions of about 1, about ½, and about 7/25, respectively.

6. The stringed musical instrument of claim 5, wherein the second and third string sections subtend an angle of about 60 degrees relative to one another, and wherein each of the second and third string sections subtends an angle of about 150 degrees relative to the first string section.

7. The stringed musical instrument of claim 1, wherein geometric and physical characteristics of the first, second, and third string sections are selected such that a vibrational frequency spectrum of the at least one string network is substantially quasi-harmonic when the at least one string network is excited.

8. The stringed musical instrument of claim 1, wherein the at least one string network comprises a plurality of string networks supported by the frame in mutually parallel planes, and wherein junction rings of the plurality of string networks are substantially aligned along a common axis extending substantially perpendicular to the mutually parallel planes.

9. The stringed musical instrument of claim 2, further comprising a retractable string-installation device disposed along an edge of the central cavity, the retractable string-installation device being movable between a retracted position in which the retractable string-installation device is housed within the central cavity and a deployed position in which the retractable string-installation device projects from the central cavity, wherein the retractable string-installation device includes a plurality of notches each configured to receive a respective junction ring during installation of a corresponding string network.

10. The stringed musical instrument of claim 2, further comprising a movable bridge disposed adjacent the central cavity, the movable bridge being movable between an operative position in which the movable bridge supports or positions at least one of the first, second, and third string sections and a retracted position in which the movable bridge is displaced away from the at least one of the first, second, and third string sections.

11. The stringed musical instrument of claim 1, further comprising a capo mounted to the frame and movable between a released position and an engaged position, wherein, in the engaged position, the capo bears against at least one of the first, second, and third string sections to selectively shorten an effective vibrating length of the at least one string section.
